(19) United States
(12) Patent Application Publication
(10) Pub. No.: US 2003/0091289 A1
(43) Pub. Date: May 15, 2003

(54) Planar lightwave circuit module and method for manufacturing the same

(75) Inventors: Tsunetoshi Saito, Tokyo (JP); Junichi Hasegawa, Tokyo (JP); Kanji Tanaka, Tokyo (JP); Kazuhisa Kashihara, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: The Furukawa Electric Co., Ltd., Chiyoda-ku (JP)

(21) Appl. No.: 10/287,531

(22) Filed: Nov. 5, 2002

(30) Foreign Application Priority Data
Nov. 15, 2001 (JP) 2001-350202

(51) Int. Cl. G02B 6/30; G02B 6/12

(52) U.S. Cl. 385/49; 385/14

(57) ABSTRACT

A planar lightwave circuit module includes a plate provided on a substrate. An end array surface of an optical fiber array is connected to an end substrate surface of the substrate and an end plate surface of the plate such that at least one optical fiber of the optical fiber array is connected to at least one optical waveguide formed on an upper substrate surface of the substrate and such that a bottom substrate surface of the substrate and a bottom array surface of the optical fiber array are substantially on a first plane and/or an upper plate surface of the plate and an upper array surface of the optical fiber array are substantially on a second plane.

### CROSS-REFERENCE TO RELATED APPLICATIONS

The present application claims priority to Japanese Patent Application No. 2001-350202, filed Nov. 15, 2001. The contents of that application are incorporated herein by reference in their entirety.

### BACKGROUND OF THE INVENTION

1. Field of the Invention

The present invention relates to a planar lightwave circuit module and a method for manufacturing the same.

2. Discussion of the Background

Currently, in the field of the optical communications, in view of the reduction in the cost and high integration, practical applications of a planar lightwave circuit (PLC) component, in which a plurality of optical waveguide circuits are arranged on a silicon substrate or silica substrate, have been proceeding. Also, as the planar lightwave circuit component has become multi-functional, the lightwave circuits arranged therein has become highly integrated.

The planar lightwave circuit component is generally made into a module by being connected to an optical fiber array formed by arranging optical fibers. Referring to FIG. 5, the planar lightwave circuit module is formed by connecting optical fiber arrays 1 (1a, 1b) to an input side and an output side of a planar lightwave circuit component 30, for example.

In the planar lightwave circuit component 30, a waveguide forming region 10 having one or more optical waveguides is formed on a substrate 11 for forming the optical waveguides. Although there are various optical waveguides to be formed on the waveguide forming region 10, and the example shown in FIG. 5 includes one optical input waveguide 2 and eight optical output waveguides 6. The circuit structure of the planar lightwave circuit component 30 is such that the optical input waveguide 2 branches at a branch section 47 to form the optical output waveguides 6.

The planar lightwave circuit component 30 is a splitter type planar lightwave circuit component (1×8 splitter) in which light inputted from one optical input section 41 (input side of the optical input waveguide 2) branches to be outputted from eight optical output sections (output sides of the optical output waveguides 6, not shown in FIG. 5).

Respective connection end surface sides (two opposing end surface sides) of the planar lightwave circuit component 30 include upper plates 43, 44 made of glass on an upper surface side of the waveguide forming region 10. The upper plates 43, 44 have roles for achieving a mechanically stable and extremely strong connection upon connecting the planar lightwave circuit component 30 to the optical fiber arrays 1.

The optical fiber arrays 1 (1a, 1b) respectively include guide substrates 23 (23a, 23b) and holding plates 24 (24a, 24b).

The optical fibers 7 are fixed between the guide substrates 23 (23a, 23b) and the holding plates 24 (24a, 24b) by using, for example, an adhesive (not shown in FIG. 5), normally.

In the lightwave circuit module shown in FIG. 5, one optical fiber 7 is fixed at the optical fiber array 1 (1b) at the input side, and this optical fiber 7 is connected to the optical input waveguide 2 of the planar lightwave circuit component 30. Incidentally, the optical fiber 7 is inserted into the optical fiber arrangement guide groove described above in the state that the a coating of the optical fiber 7 at a connection end surface side is removed. The optical fiber 7 inserted into the optical fiber arrangement guide groove is held by the holding plate 24 (24b).

FIG. 9(a) schematically shows a section of one end side of the planar lightwave circuit component 30 applied to the lightwave circuit module shown in FIG. 5. The section shown in FIG. 9(a) is a section of the planar lightwave circuit component 30 at the optical fiber array 1 (1a) side, and the optical output waveguides 6 are formed in the waveguide forming region 10.

Also, FIG. 9(b) schematically shows a section of the optical fiber array 1 (1a) applied to the lightwave circuit module shown in FIG. 5. The dimensions shown in FIGS. 9(a) and 9(b) do not accord with the actual dimensions. However, FIGS. 9(a) and 9(b) show the positional relationship between the planar lightwave circuit component 30 and the optical fiber array 1 for better understanding by aligning a central position of the optical fiber 7 with the center of the optical output waveguide 6 as the optical waveguide of the planar lightwave circuit component 30.

In the conventional lightwave circuit module, the thickness (a) of the substrate 11 of the planar lightwave circuit component 30 shown in FIG. 9(a) is about 1.0 mm, and the thickness (k) of the waveguide forming region 10 is 50 μm. The thickness (b) of the upper plate 44 shown in FIG. 9(b) is 1.0 mm.

Also, an upper surface 15 of the upper plate 44 constitutes the upper surface 15 of the planar lightwave circuit component 30. A distance designated as (f) in FIG. 9(a) between a center of a thickness direction of the optical waveguide (here, the optical output waveguide 6), which is formed on the planar lightwave circuit component 30, and the upper surface 15 of the planar lightwave circuit component 30 is about 1.03 mm, and a distance designated as (e) in FIG. 9(a) between a center of a thickness direction of the optical output waveguide 6 and a bottom surface 17 of the substrate 11 is about 1.02 mm.

Although not shown in FIGS. 9(a) and 9(b), the structure of the thicknesses in the other end side of the planar lightwave circuit component 30 is the same as in the one described above. In other words, an upper surface 14 of the upper plate 43 shown in FIG. 5 constitutes the upper surface 14 of the planar lightwave circuit component 30. A distance between a center of a thickness direction of the optical input waveguide 2, which is formed on the planar lightwave circuit component 30, and the upper surface 14 of the planar lightwave circuit component 30 is about 1.03 mm, and a distance between a center of a thickness direction of the optical input waveguide 2 and a bottom surface 17 of the substrate 11 is about 1.02 mm.

On the other hand, a thickness, for example, designated as (c) in FIG. 9(b), of the guide substrate 23 of the optical fiber array 1 (1a) is about 1.00 mm. The diameter of the optical fiber 7 inserted into the optical fiber arrangement guide groove 9 of the guide substrate 23 is 0.125 mm, and a distance designated as (g) in FIG. 9(b) between the center of the optical fiber 7 and a bottom surface 18 of the holding plate 24 is about 0.95 mm. A thickness, designated as (d) in FIG. 9(b), of the holding plate 24 is 1.00 mm, and a distance designated as (h) in FIG. 9(b) between the center of the optical fiber 7 and an upper surface 16 of the holding plate 24 is about 1.06 mm.

As shown in FIG. 9(b), when a core of the planar lightwave circuit component 30 and the center of the optical fiber 7 are aligned and the planar lightwave circuit component 30 and optical fiber array 1 are connected, a step, designated as (i) in FIG. 9(b), of about 0.03 mm is formed between the upper surface 15 of the upper plate 44 and the upper surface 16 of the holding plate 24. Also, a step, designated as (j) in FIG. 9(b), of about 0.07 mm is formed between the bottom surface 17 of the planar lightwave circuit component 30 and the bottom surface 18 of the guide substrate 23.

The optical fiber array 1 (1b) have the same structure as that of the optical fiber array 1 (1a) except that the number of the optical fiber arrangement groove 9 and the number of the optical fiber 7 is one. The positional relationship between the connection end surface side of the optical fiber array 1 (1b) and the connection end surface of the optical input waveguide 2 of the planar lightwave circuit component 30 is the same as that shown in FIGS. 9(a) and 9(b).

FIG. 10(a) show a side view of the lightwave circuit module, which has the thickness structure as same as that of the lightwave circuit module shown in FIG. 5. In the lightwave circuit module shown in FIG. 10(a), the connection end surfaces of the planar lightwave circuit component 30 and the connection end surfaces of the optical fiber arrays 1 (1a, 1b) are oblique to the plane orthogonal to the Z direction.

FIG. 10(b) shows a magnified view of an inside of a circle (A) shown by a broken line in FIG. 10(a), and the inside of the circle (A) shows the connection section between the planar lightwave circuit component 30 and the optical fiber array (1 (1a). The connection section is provided with an adhesive 40.

### SUMMARY OF THE INVENTION

According to one aspect of the present invention, a planar lightwave circuit module includes a planar lightwave circuit component, a plate and an optical fiber array. The planar lightwave circuit component includes a substrate having upper, bottom and end substrate surfaces. A waveguide forming region includes at least one optical waveguide which is formed on the upper substrate surface. The plate has upper, bottom and end plate surfaces and is provided on the substrate such that the bottom plate surface of the plate contacts the waveguide forming region. The optical fiber array includes upper, bottom and end array surfaces and at least one optical fiber. The end array surface of the optical fiber array is connected to the end substrate surface of the substrate and the end plate surface of the plate such that the at least one optical fiber is connected to the at least one optical waveguide and such that the bottom substrate surface of the substrate and the bottom array surface of the optical fiber array are substantially on a first plane and/or the upper plate surface of the plate and the upper array surface of the optical fiber array are substantially on a second plane.

According to another aspect of the present invention, a method for manufacturing a planar lightwave circuit module includes forming a waveguide forming region including at least one optical waveguide on an upper substrate surface of a substrate of a planar lightwave circuit component. A plate is provided on the substrate such that a bottom plate surface of the plate contacts the waveguide forming region. An end array surface of an optical fiber array is connected to an end substrate surface of the substrate and an end plate surface of the plate such that at least one optical fiber of the optical fiber array is connected to the at least one optical waveguide and such that a bottom substrate surface of the substrate and a bottom array surface of the optical fiber array are substantially on a first plane and/or an upper plate surface of the plate and an upper array surface of the optical fiber array are substantially on a second plane.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1(a) is a side view showing a main section of a lightwave circuit module according to a first embodiment of the present invention;

FIG. 1(b) is an enlarged view of a connection section in the lightwave circuit module shown in FIG. 1(a);

FIG. 1(c) is a perspective view of the lightwave circuit module shown in FIG. 1(a);

FIG. 2(a) is a cross-sectional view of the lightwave circuit module shown in FIG. 1(a) taken along a line II(a)-II(a);

FIG. 2(b) is a cross-sectional view of the lightwave circuit module shown in FIG. 1(a) taken along a line II(b)-II(b);

FIG. 3 is a schematic view showing a main section of a lightwave circuit module according to a second embodiment of the present invention;

FIG. 4(a) is a cross-sectional view of the lightwave circuit module shown in FIG. 3 taken along a line IV(a)-IV(a);

FIG. 4(b) is a cross-sectional view of the lightwave circuit module shown in FIG. 3 taken along a line IV(b)-IV(b);

FIG. 5 is a perspective view showing a conventional lightwave circuit module;

FIG. 6 is an explanatory view showing a structural example of the optical fiber array;

FIGS. 7(a) and 7(b) are schematic views explaining how to arrange optical fibers in optical fiber arrangement guide grooves;

FIG. 8 is an explanatory view showing a structural example of an arrayed waveguide grating;

FIG. 9(a) is a cross-sectional view of a lightwave circuit module shown in FIG. 5 taken along a line IX(a)-IX(a);

FIG. 9(b) is a cross-sectional view of the lightwave circuit module shown in FIG. 5 taken along a line IX(b)-IX(b);

FIG. 10(a) is a schematic side view of the conventional lightwave circuit module;

FIG. 10(b) is a schematic enlarged view of a connection section in the conventional lightwave circuit module shown in FIG. 10(a);

FIG. 11(a) is a side view of a lightwave circuit module as a comparative example with respect to the second embodiment of the lightwave circuit module;

FIG. 11(b) is an enlarged view of a connection section in the lightwave circuit module shown in FIG. 11(a);

FIG. 12(a) is a side view of a lightwave circuit module as another comparative example with respect to the second embodiment of the lightwave circuit module;

FIG. 12(b) is an enlarged view of a connection section in the lightwave circuit module shown in FIG. 12(a); and

### DESCRIPTION OF THE EMBODIMENTS

The embodiments will now be described with reference to the accompanying drawings, wherein like reference numerals designate corresponding or identical elements throughout the various drawings.

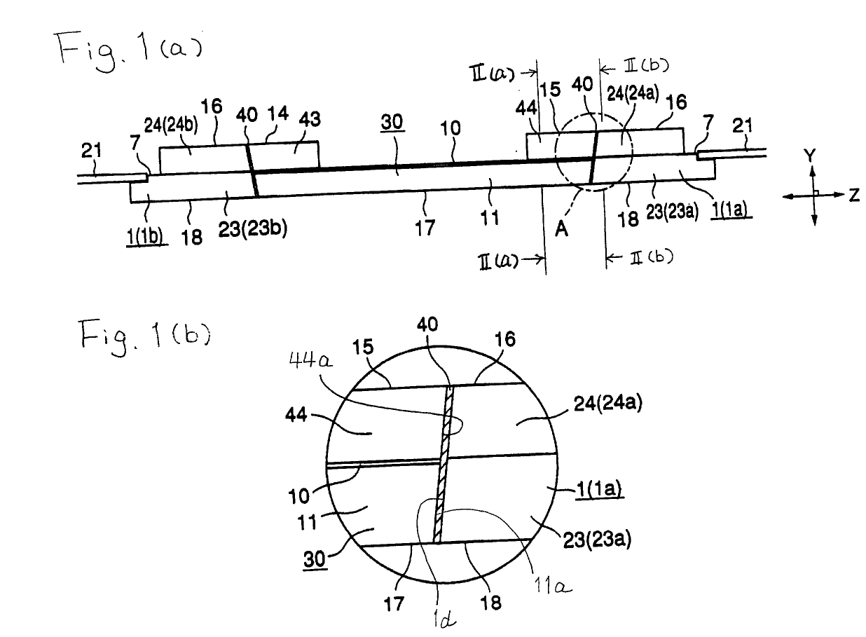

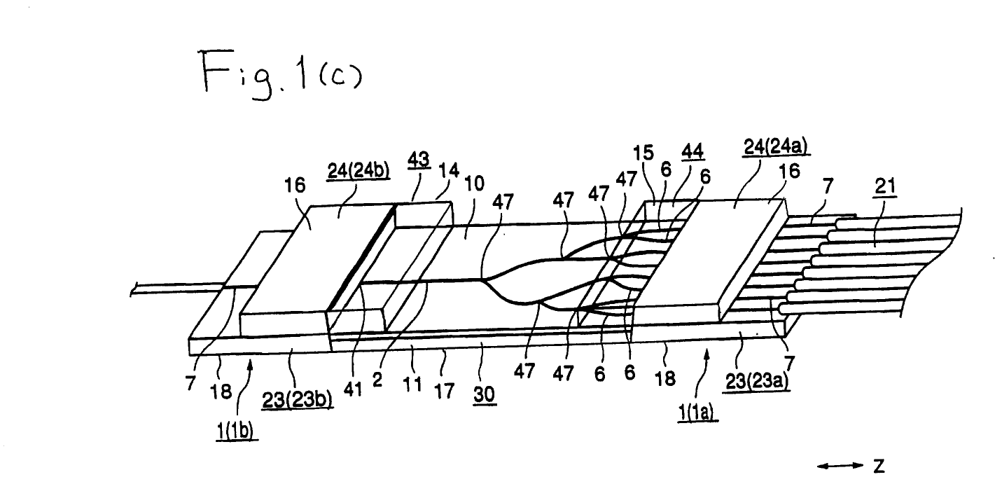

FIG. 1(a) is a side view showing a first embodiment of a lightwave circuit module according to the present invention, FIG. 1(b) shows an enlarged view of a portion circled by a broken line (A) in FIG. 1(a), and FIG. 1(c) is a perspective view of the lightwave circuit module shown in FIG. 1(a).

The planar lightwave circuit component is generally made into a module by being connected to an optical fiber array formed by arranging optical fibers. Referring to FIG. 1(c), the planar lightwave circuit module is formed by connecting optical fiber arrays 1 (1a, 1b) to an input side and an output side of a planar lightwave circuit component 30, for example.

In the planar lightwave circuit component 30, a waveguide forming region 10 having one or more optical waveguides is formed on an upper substrate surface of a substrate 11 for forming the optical waveguides. Although there are various optical waveguides to be formed on the waveguide forming region 10, the example shown in FIG. 1(c) includes one optical input waveguide 2 and eight optical output waveguides 6. The circuit structure of the planar lightwave circuit component 30 is such that the optical input waveguide 2 branches at a branch section 47 to form the optical output waveguides 6.

The planar lightwave circuit component 30 is, for example, a splitter type planar lightwave circuit component (1×8 splitter) in which light inputted from one optical input section 41 (input side of the optical input waveguide 2) branches to be outputted from eight optical output sections.

Upper plates (43, 44) made of glass are provided on an upper surface of the waveguide forming region 10 at end portions of the planar lightwave circuit component 30. The upper plates 43, 44 have a function to achieve a mechanically stable and extremely strong connection upon connecting the planar lightwave circuit component 30 to the optical fiber arrays 1.

The optical fiber arrays 1 (1a, 1b) respectively include guide substrates 23 (23a, 23b) and holding plates 24 (24a, 24b).

Although not shown in FIG. 1(c), the guide substrates 23 (23a, 23b) respectively include one or more optical fiber arrangement guide grooves. Each optical fiber arrangement guide groove is normally formed in a V-shaped groove, and optical fibers 7 are respectively inserted into the optical fiber arrangement guide grooves to be fixed. The optical fibers 7 are held by the holding plates 24 (24a, 24b).

The optical fibers 7 are fixed between the guide substrates 23 (23a, 23b) and the holding plates 24 (24a, 24b) by using, for example, an adhesive 40 (see FIG. 1(b)), normally.

In the lightwave circuit module shown in FIG. 1(c), one optical fiber 7 is fixed at the optical fiber array 1 (1b) at the input side, and this optical fiber 7 is connected to the optical input waveguide 2 of the planar lightwave circuit component 30. Incidentally, the optical fiber 7 is inserted into the optical fiber arrangement guide groove described above in the state that the a coating of the optical fiber 7 at a connection end surface side is removed. The optical fiber 7 inserted into the optical fiber arrangement guide groove is held by the holding plate 24 (24b).

Also, eight optical fibers 7 are arranged and fixed at equal pitch in the optical fiber array 1 (1a) at the output side. These optical fibers 7 are drawn from optical fiber tape core wires 21 and inserted into the optical fiber arrangement guide grooves in the state that the coatings of the optical fibers 7 at the connection end surfaces are removed, and held by the holding plate 24 (24a). These optical fibers 7 are connected to the corresponding optical output waveguides 6 of the planar lightwave circuit component 30. Incidentally, the optical fiber tape core wires 21 are arranged side by side in one row at the pitch of, for example, 250 μm, which is substantially twice as the diameter of the core wire 21.

Generally, the arrangement pitch of the optical fiber arrangement guide grooves formed in the guide substrate 23 of the optical fiber array 1 is, for example, 250 μm which is equal to the arrangement pitch of the optical fibers 7 in the optical fiber tape core wire 21. Also, the arrangement pitch of the optical fiber arrangement guide grooves may be, for example, 127 μm, which is substantially the same as the diameter of the optical fiber 7. In the case where the arrangement pitch of the optical fiber arrangement guide grooves is substantially the same as the diameter of the optical fiber 7, the optical fibers 7 can be arranged side by side without having almost no space therebetween.

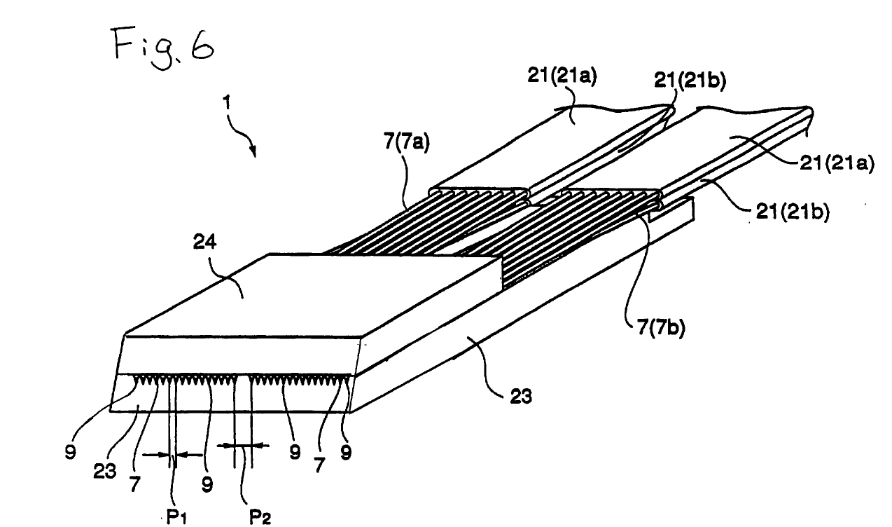

FIG. 6 shows an example of the optical fiber array 1. In the optical fiber array 1 shown in FIG. 6, for example, thirty-two optical fiber arrays 7 are arranged at the arrangement pitch substantially the same as the diameter of the optical fiber 7. In the guide substrate 23, optical fiber arrangement guide grooves 9 are formed at an arrangement pitch (P₁) of, for example, 127 μm which is substantially the same as the diameter of the optical fiber 7, and the optical fibers 7 are respectively inserted into the optical fiber arrangement guide grooves 9.

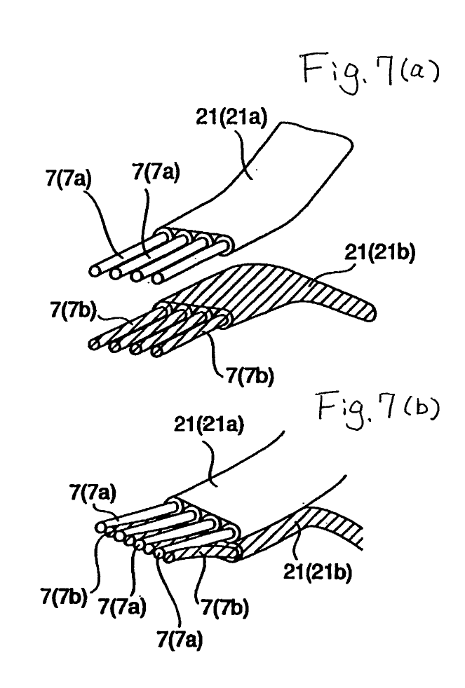

In this case, as shown in FIG. 6, the optical fiber array 1 is provided with the optical fiber tape core wires 21 (21a, 21b) which are stacked in two layers. Then, as schematically shown in FIGS. 7(a) and 7(b), for example, the optical fibers 7 (7a) arranged in the optical fiber tape core wire (21a) and the optical fibers 7 (7b) arranged in the optical fiber tape core wire (21b) are arranged.

In other words, as shown in FIG. 7(a), the distal end sides of the optical fiber 7 (7a) are arranged side by side at the pitch of, for example, about 127 μm, and the optical fibers 7 (7a) and the optical fibers 7 (7b) are arranged alternately as shown in FIG. 7(b). Then, as shown in FIG. 6, these optical fibers 7 (7a, 7b) are inserted into the optical fiber arrangement guide grooves 9 formed in the guide substrate 23 (23a), to thereby form the optical fiber array 1.

Then, as shown in FIG. 6, in the optical fiber array in which a plurality of the optical fiber tape core wires 21 are arranged side by side, the arrangement pitch (P₂) of the optical fibers between the adjacent optical fiber tape core wires 21 may be set slightly larger than the arrangement pitch (P₁) of the optical fibers 7 in the single optical fiber tape core wire 21. This structure can prevent the interference between the optical fiber tape core wires 21, in other words, the structure can prevent the coatings of the adjacent fiber tape core wires 21 from colliding with each other.

In this structure, in case the arrangement pitch (P₁) of the optical fiber arrangement guide grooves is 127 μm, the arrangement pitch (P₂) of the optical fibers 7 between the adjacent tapes are set at 254 to 500 μm, for example. Also, in case the arrangement pitch (P₁) of the optical fiber arrangement guide grooves is 250 μm, the arrangement pitch (P₂) of the optical fibers 7 between the adjacent tapes are set at 360 to 500 μm, for example.

In the lightwave circuit module shown in FIG. 1(c), after the connection end surfaces of the optical fiber arrays 1 (1a, 1b) and the connection end surfaces of the planar lightwave circuit component 30 are respectively polished or ground, the optical fiber array 1 (1b) and the input side end surface of the planar lightwave circuit component 30 are opposed to each other, and the optical fiber array 1 (1a) and the output side end surface of the planar lightwave circuit component 30 are opposed to each other.

Referring to FIGS. 1(b) and 1(c), the connection end surfaces of the planar lightwave circuit component 30 and the connection end surfaces of the optical fiber arrays 1 (1a, 1b) are oblique to a plane which is perpendicular to the Z direction as shown in FIG. 1(c). In case the connection end surfaces of the planar lightwave circuit component 30 and the connection end surfaces of the optical fiber arrays 1 (1a, 1b) are formed oblique to the plane perpendicular to the Z direction, the reflection of the light at the connection end surfaces can be suppressed.

By arranging the connection end surfaces of the optical fiber arrays 1 (1a, 1b) and the connection end surfaces of the planar lightwave circuit component 30 to be opposed to each other, the optical fibers 7 of the optical fiber arrays 1 (1a, 1b) and the optical waveguides (optical input waveguide 2 and the optical output waveguides 6 in the example of FIG. 1(c)) are arranged to be opposed to each other.

Then, the alignment is made such that the axial shift (positional shift) between the connection end surface of the optical fiber 7 and the connection end surface of the optical waveguide opposed to each other become minimum. At this aligned position, the connection end surfaces of the optical fiber arrays 1 (1a, 1b) and the connection end surfaces of the planar lightwave circuit component 30 are bonded to be fixed by the ultraviolet (UV) curing adhesive or the like.

The alignment described above is conducted as follows, for example. Namely, a first positioning is conducted such that the optical waveguides arranged in the planar lightwave circuit component 30 and the optical fibers 7 arranged in the optical fiber array 1 are positioned to be optically connected to each other.

Since the optical waveguides and the optical fibers 7 need to be positioned to the degree they are optically connected to each other, the first positioning requires at least positioning accuracy of 5 to 10 μm. Therefore, in the first positioning, the connection section between the planar lightwave circuit component 30 and the optical fiber array 1 are observed by magnifying the connection section by using a stereoscopic microscope or highly magnifying CCD (charge coupled device) camera, and the positioning accuracy of these sections are obtained.

Then, light is allowed to pass though the optical waveguide and the optical fiber 7 positioned by the first positioning, and the transmitted light is monitored by an optical power meter. Meanwhile, at least one of the optical waveguide and the optical fiber 7 is moved and precisely positioned such that the transmitted light becomes maximum. This positioning is called as the second positioning, and the alignment is finished by the second positioning.

In the lightwave circuit module described above, for example, a thickness of the substrate 11 of the planar lightwave circuit component 11 is generally 1.0 mm, and a thickness of the waveguide forming region 10 is approximately 50 μm. Incidentally, in view of the economical efficiency, the substrate 11 is generally formed by using a commercial available silicon wafer with the thickness of 1.0 mm in many cases, the substrate 11 generally has the thickness of 1.0 mm.

Incidentally, although the upper plates 43, 44 are disposed only at the connection surface sides of the planar lightwave circuit component 30 in FIG. 1(c), there is a planar lightwave circuit component 30 in which the upper plates are formed on the entire region of the upper side of the waveguide forming region 10. Also, the upper plates are not always formed at both end sides of the planar lightwave circuit component 30, and may be formed at only one end side of the light circuit component 30. Further, depending on the embodiment of the waveguide structure, the upper plates may be formed at two adjacent end surfaces.

Also, the lightwave circuit module is not limited to the one formed by connecting the planar lightwave circuit component 30 to the optical fiber array 1 having the guide substrate 23 and the holding plate 24. For example, there is the lightwave circuit module, in which the optical fiber array, such as an optical fiber ferrule having the insertion hole for the optical fiber 7, is connected to the planar lightwave circuit component 30.

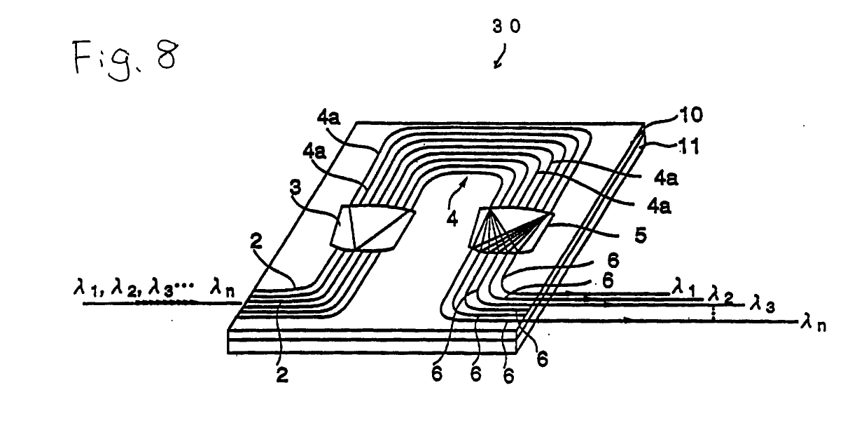

Also, although various structural examples of the planar lightwave circuit component 30 have been known, other than the splitter described above, the arrayed waveguide grating (AWG) shown in FIG. 8, for example, has been widely known.

The arrayed waveguide grating has a role as a wavelength multiplexer/demultiplexer in the wavelength division multiplexing transmission. The wavelength multiplexing transmission is a transmission system, in which a plurality of lights having wavelengths different from each other are multiplexed and transmitted by the single optical fiber, to thereby dramatically improve the transmission amount.

Referring to FIG. 8, the waveguide structure of the arrayed waveguide grating includes one of more optical input waveguides 2; a first slab waveguide 3 connected to output sides of the optical input waveguides 2; an arrayed waveguide 4, which are connected to an arranged side of the first slab waveguide 3 and formed of a plurality of channel waveguides (4a) arranged side by side; a second slab waveguide 5 connected to an output side of the arrayed waveguide 4; and a plurality of optical output waveguides 6, which are arranged side by side and connected to an output side of the second slab waveguide 5.

The arrayed waveguide 4 propagate a light that has been let from the first slab waveguide 3, and is formed such that the lengths of the adjacent channel waveguides (4a) vary from each other by a predetermined length (ΔL).

Incidentally, the optical output waveguides 6 correspond to the number of signal lights of the the wavelengths different from each other, that are demultiplexed or multiplexed by the arrayed waveguide grating, for example. The channel waveguides (4a) are normally disposed in multiple such as one hundred. However, in FIG. 8, the number of the optical output waveguides 6, the channel waveguides (4a), and the optical input waveguides 2 are schematically depicted to simplify the drawing.

The optical input waveguides 2 are connected to the optical fiber (not shown in the figure) in the transmitting side, and the multiplexed light is led thereinto. The light that has been led into the first slab waveguide 3 through the optical input waveguides 2 is diffracted by the diffraction effect to enter the arrayed waveguide 4, and the diffracted lights are propagated through the arrayed waveguide 4.

The lights that have been propagated the arrayed waveguide 4 reach the second slab waveguide 5, and the lights are focused at the optical output waveguides 6 to be outputted. Since the lengths of the adjacent channel waveguides (4a) in the arrayed waveguide 4 are different from each other by the predetermined length, after the lights are propagated in the arrayed waveguide 4, phases of the respective lights are shifted. Accordingly, wavefronts of the focused lights are tilted in accordance with the shifted amount, and the positions at which the lights are focused are determined by the tilted angle.

Therefore, in the lights having the different wavelengths, the positions where the lights are focused are different from each other, and by forming the optical output waveguides 6 at the light focused positions, the lights (demultiplexed lights) having the different wavelengths can be outputted from the different optical output waveguides 6 at every wavelength.

In other words, the arrayed waveguide grating has an optical demultiplexing function for demultiplexing the light having one or more wavelengths from the multiplexed light, which is inputted from the optical input waveguides 2 and has a plurality of wavelengths different from each other. A center wavelength of the demulplexed lights is in proportion to the length difference (ΔL) of the adjacent channel waveguides (4a) of the arrayed waveguide 4 and an effective refractive index or equivalent refractive index (n_{c}) of the channel waveguide (4a).

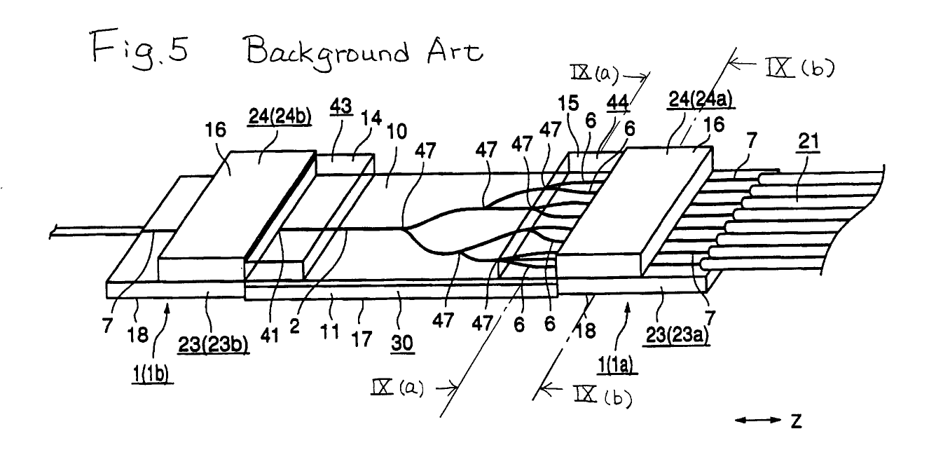

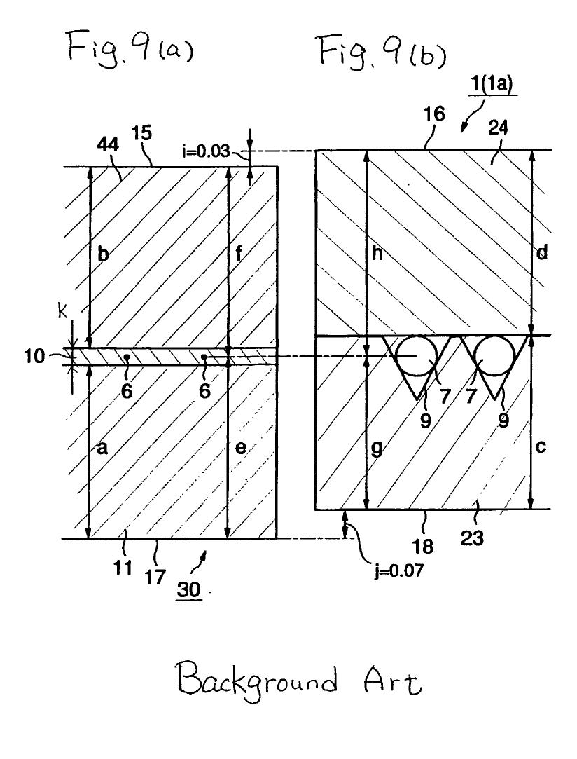

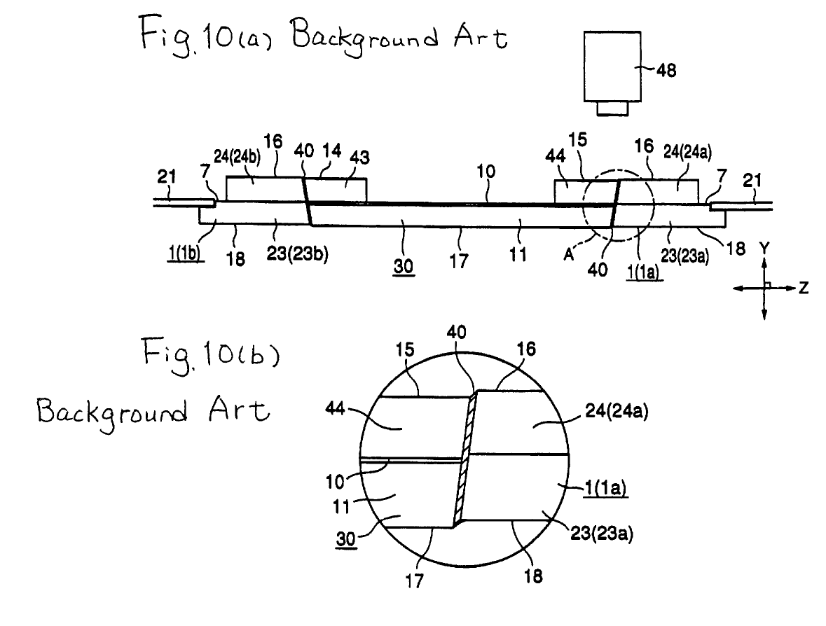

As shown in FIG. 5, FIGS. 9(a) and 9(b), and FIGS. 10(a) and 10(b), since there is the step at the connection section between the lightwave circuit component 30 and the optical fiber array 1 in the conventional lightwave circuit module, there has been a problem that, for example, the alignment between the optical waveguide of the lightwave circuit component 30 and the optical fiber 7 of the optical fiber array 1 can not be carried out precisely.

This is because of the following reason. If there is the step between the lightwave circuit component 30 and the optical fiber array 1, a CCD camera 48 or the like shown in FIG. 10(a) can not be focused at both lightwave circuit component 30 and the optical fiber array 1 at the same time. Therefore, the optical waveguide and the optical fiber 7 can not be optically precisely positioned by using the stereoscopic microscope or CCD camera 48. In other words, if there is the step between the lightwave circuit component 30 and the optical fiber array 1, the first positioning described above can not be conducted accurately.

Especially, positioning in a vertical direction, for example, Y direction shown in FIG. 10(a), needs to be based on the position where the stereoscopic microscope is focused both at the lightwave circuit component 30 and the optical fiber array 1. However, if it is adjusted that the stereoscopic microscope is focused both at the lightwave circuit component 30 and the optical fiber array 1, the optical axes of the optical waveguide of the lightwave circuit component 30 and the optical fiber 7 of the optical fiber array 1 are shifted. In that case, the second positioning to be conducted after the first positioning can not be carried out.

Also, the adhesive 40 is provided at the connection section between the lightwave circuit component 30 and the optical fiber array 1. In the lightwave circuit module, the thickness of the adhesive 40 needs to be about 5 μm.

However, in the conventional lightwave circuit module, since there are steps respectively between the upper surfaces 14, 15 of the lightwave circuit component 30 and the upper surface 16 of the optical fiber array 16, a space between the connection end surface of the lightwave circuit component 30 and the connection end surface of the optical fiber array 1 can not be seen. Also, since there is the step between the bottom surface 17 of the lightwave circuit component 30 and the bottom surface 18 of the optical fiber array 1, a space between the connection end surface of the lightwave circuit component 30 and the connection end surface of the optical fiber array 1 can not be seen.

Therefore, in the conventional lightwave circuit module, there has been a problem that the space between the lightwave circuit component 30 and the optical fiber array 1 can not be determined precisely, and the thickness of the adhesive 40 provided in the space varies.

Also, if there is the step in the connection section between the lightwave circuit component 30 and the optical fiber array 1, as shown in FIG. 10(b), the adhesive 40 is accumulated at the step. Thus, the stress is applied at the connection section between the lightwave circuit component 30 and the optical fiber array 1, so that the reliability at the connection section is lowered.

Further, if there is step at the connection section between the lightwave circuit component 30 and the optical fiber array 1, when it is inspected by the microscope or the like to see whether there is problem in the connection section between lightwave circuit component 30 and the optical fiber array 1 after the lightwave circuit module is fabricated, it is difficult to observe the connection section by the microscope. Therefore, there has been a problem that the lightwave circuit module having the problem in the connection section is missed if there is the step in the connection section between the lightwave circuit component 30 and the optical fiber array 1.

Referring to FIGS. 1(a)-1(c), in the planar lightwave circuit component 30, the waveguide forming region 10 is formed on the silicon substrate 11, and the upper plates 43, 44 made of glass are disposed at the end portions of the planar lightwave circuit component 30. The waveguide forming region 10 includes a circuit of the arrayed waveguide grating having a channel interval of 100 GHz and sixteen channels.

Also, the optical fiber array 1 (1a) is formed by arranging sixteen optical fibers 7 to correspond to the planar lightwave circuit component 30. The optical fiber array 1 (1b) is formed by arranging one optical fiber 7.

In the embodiment, the connection end surfaces of the planar lightwave circuit component 30 and the optical fiber arrays 1 (1a, 1b) in the embodiment are formed to be obliquely and polished. The end substrate surface (11a) of the substrate, the end plate surface (44a), and the end array surface (1d) are formed to be obliquely and polished (FIG. 1(b)).

The upper surfaces 14 and 15 of the planar lightwave circuit component 30 and the upper surface 16 of the optical fiber array I are formed on the substantially same first plane, and the bottom surface 17 of the substrate of the planar lightwave circuit component 30 and the bottom surface 18 of the optical fiber array 1 are formed on the same second plane as shown in FIG. 1(a) and FIG. 1(b).

In other words, in the ligthwave circuit module according to the present embodiment of the present invention, there is no step in the connection section between the planar lightwave circuit component 30 and the optical fiber array 1 both at the upper surface 14, 15, 16 side and the bottom surface 17, 18 side.

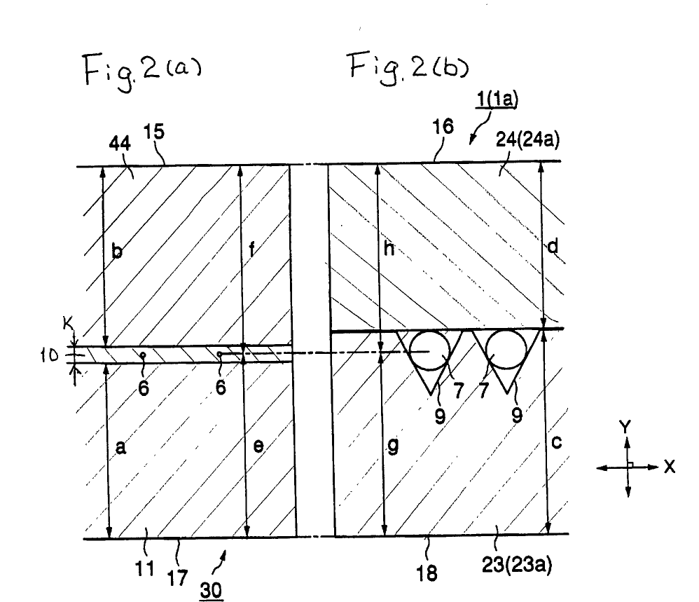

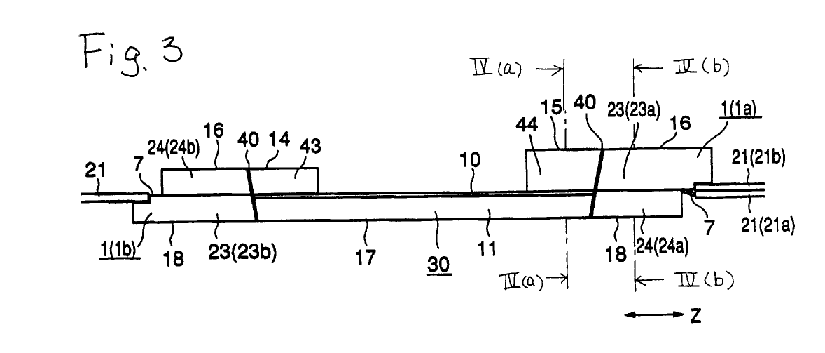

As shown in FIG. 2(a), the thickness, designated as (a) in FIG. 2(a), of the substrate 11 is 1.0 mm, and the thickness (k) of the waveguide forming region 10 is 50 μm (0.05 mm). However, in the embodiment of the invention, each of the thickness (not shown) of the upper plate 43 and the thickness, designated as (b) in FIG. 2(a), of the upper plate 44 is about 0.95 mm.

As shown in FIG. 2(b), the thickness, designated as (c) in FIG. 2(b), of the guide substrate 23 (23a) of the optical fiber array 1 (1a) is about 1.07 mm, and a thickness, designated as (d) in FIG. 2(b), of the holding plate 24 (24a) is about 0.92 mm. Additionally, one optical fiber arrangement guide groove 9 and one optical fiber 7 are exposed at the connection end surface of the optical fiber array 1 (1b), and the thickness structure of the optical fiber array 1 (1b) is the same as that of the optical fiber array 1 (1b).

Also, a distance designated as (e) in FIG. 2(a) between a center of a thickness direction of the optical waveguide, which is formed in the planar lightwave circuit component 30 to constitute the optical output waveguide 6 in FIG. 2(a), and the bottom surface 17 of the planar lightwave circuit component 30 is equal to a distance designated as (g) in FIG. 2(b) between the center of the optical fiber 7 of the optical fiber array 1 (1a) and the bottom surface 18 of the optical fiber array 1 (1a). Each of the distance (e) and the distance (g) is about 1.02 mm.

A distance designated as (f) in FIG. 2(a) between the upper surface 15 of the planar lightwave circuit component 30 and the center of the thickness direction of the optical output waveguide 6 formed on the planar lightwave circuit component 30 is equal to a distance designated as (h) in FIG. 2(b) between the center of the optical fiber 7 of the optical fiber array 1 (1a) and the upper surface 16 of the optical fiber array 1. Each of the distance (f) and the distance (h) is about 0.98 mm.

Although FIGS. 2(a) and 2(b) show the connection side surface of the planar lightwave circuit component 30 at the optical fiber array 1 (1a) side and the connection side surface of the optical fiber array 1 (1a), the connection end surface side of the planar lightwave circuit component 30 at the optical fiber array 1 (1b) has a thickness structure similar to the structure shown in FIGS. 2(a) and 2(b).

In other words, instead of the output optical waveguides 6, one optical input waveguide 2 is formed at the connection end surface of the planar lightwave circuit component 30 at the optical fiber array 1 (1b), and a distance between the optical input waveguide 2 and the upper surface 14 of the planar lightwave circuit component 30 is substantially equal to the distance between the optical output waveguide 6 and the upper surface 15 of the planar lightwave circuit component 30. Also, a distance between the optical input waveguide 2 and the bottom surface 17 of the planar lightwave circuit component 30 is substantially equal to the distance between the optical output waveguide 6 and the bottom surface 17.

The first embodiment of the invention is structured as described above. Since there is substantially no step at the connection section between the planar lightwave circuit component 30 and the optical fiber arrays 1 (1a, 1b) on both the upper surface 14, 15, 16 side and the bottom surface 17, 18 side, the operation of aligning the optical waveguide of the planar lightwave circuit component 30 and the optical fiber 7 of the optical fiber array 1 can be conducted efficiently and accurately.

In other words, in the embodiment of the invention, since there is substantially no step at the connection section between the planar lightwave circuit component 30 and the optical fiber arrays 1 (1a, 1b) on both the upper surface 14, 15, 16 side and the bottom surface 17, 18 side, in case the optical waveguide is aligned with the optical fiber 7, the first positioning by using the CCD camera 48 or the like can be conducted quickly and accurately, to proceed the second positioning without spending too much time.

Then, alignment between the optical waveguide of the planar lightwave circuit component 30 and the optical fiber arrays 1 (1a, 1b) can be carried out precisely by the second positioning.

Also, it is easy to check the distances between the connection end surfaces of the planar lightwave circuit component 30 and the connection end surfaces of the optical fiber arrays 1 (1a, 1b) by using the CCD camera 48 or the like, the distance can be easily adjusted, and can be formed as designed. Therefore, it can be prevented that the optical fiber 7 collides with the planar lightwave circuit component 30, and the adhesive 40 is prevented from being accumulated around the connection section.

Therefore, there is no such incidence that the stress is applied to the connection section between the planar lightwave circuit component 30 and the optical fiber array 1 to lower the reliability at the connection section. Accordingly, the lightwave circuit module with the high reliability can be achieved with the excellent yield.

FIG. 3 shows a side view of a second embodiment of the lightwave circuit module according to the present invention. In the lightwave circuit module of the second embodiment, as in the first embodiment, the connection end surfaces of the planar lightwave circuit component 30 having the circuit of the arrayed waveguide grating and the connection and surfaces of the optical fiber arrays 1 (1a, 1b) are arranged to be opposed to each other, optical fiber arrays 1 (1a, 1b) are fixed at both end sides of the planar lightwave component 30 to form the lightwave circuit module.

In the second embodiment, the planar lightwave circuit component 30 has the circuit of the arrayed waveguide grating including the channel spacing of 100 GHz and the forty-eight channels. The optical fiber arrays 1 (1a, 1b) are formed by arranging forty-eight optical fibers to correspond to this planar lightwave circuit component 30.

Also, the holding plate 24 (24a) of the optical fiber array (1a) is opposed to the substrate 11 of the planar lightwave circuit component 30, and the upper plate 44 formed in the planar lightwave circuit component 30 is opposed to the guide substrate 23 (23a) of the optical fiber array (1a).

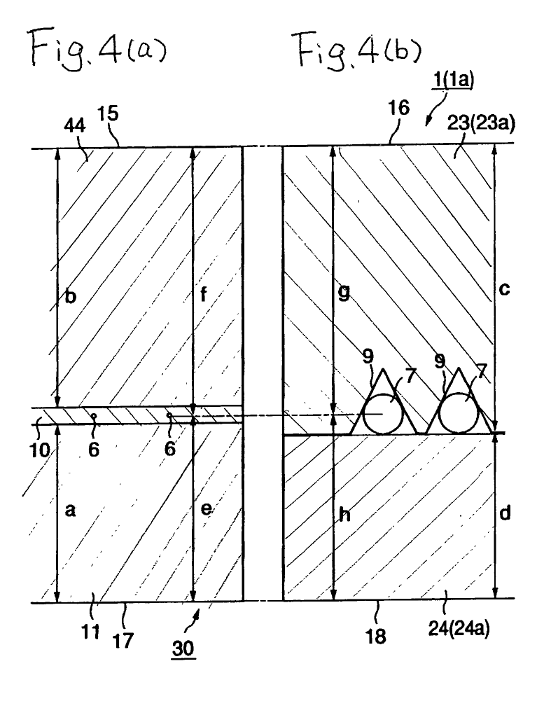

As shown in FIG. 4(b), in the optical fiber array (1a), the holding plate (24a) is disposed at the lower side, and the guide substrate (23a) is disposed upper side. Thus, the bottom surface of the guide substrate (23a) constitutes the upper surface 16 of the optical fiber array (1a). A distance designated as (g) in FIG. 4(b) between the upper surface 16 of the optical fiber array (1a) and the center of the optical fiber array 7 is about 1.44 mm, and the thickness, designated as (c) in FIG. 4(b), of the guide substrate (23a) is 1.50 mm.

Also, as shown in FIG. 4(a), a thickness, designated as (a) in FIG. 4(a), of the substrate 11 of the planar lightwave circuit component 30 is 1.00 mm, and a distance designated as (e) in FIG. 4(a) between the bottom surface 17 of the planar lightwave circuit component 30 and the center in the thickness direction of the optical waveguide (the optical output waveguide 6 in the figure) formed in the planar lightwave circuit component 30 is about 1.02 mm.

As described above, in the second embodiment, the distance (g) between the upper surface 16 of the optical fiber array (1a) and the center of the optical fiber 7 is formed to be larger than the distance (e) between the bottom surface 17 of the planar lightwave circuit component 30 and the center in the thickness direction of the optical waveguide (the optical output waveguide 6 in the figure) formed in the planar lightwave circuit component 30.

Conventionally, the planar lightwave circuit component 30 applied to the lightwave circuit module has been mainly 1×8 splitter, 1×16 splitter, or the arrayed waveguide grating which multiplex or demultiplex eight to 16 wavelengths. Therefore, in many cases, the number of the optical fibers 7 arranged in the optical fiber array 1 applied to the lightwave circuit module was eight or sixteen.

However, in recent years, the multi-functional planar lightwave circuit component 30 has been developed, and accordingly, there have been conducted the development and actual applications of the splitter type planar lightwave circuit components 30 in which the light inputted from single optical input section branches to be outputted from thirty-two optical output sections, or to be outputted from sixty-four optical output sections. In addition, there has been a practical application of the arrayed waveguide grating in which the number of multiplexing and demultiplexing wavelengths is forty or more, or even sixty or more.

As a result, in the lightwave circuit module formed by applying such a planar lightwave circuit component 30, the number of the optical fibers 7 arranged in the optical fiber array 1 needs to be 32 to 60 or more to correspond to the planar lightwave circuit component 30. However, if thirty-two to sixty or more optical fiber arrangement guide grooves are formed in the guide substrate 23 having the thickness of about 1.0 mm, which is the same as the conventional one, to thereby form the optical fiber array 1, there has been a problem that the optical fiber array 1 is largely warped in accordance with the adhesive curing contraction at the time of fixing the optical fibers 7.

Therefore, the inventors of the invention focused attention to the warping amount of the optical fiber array 1 and the thickness of the guide substrate 23, and decided to adequately form the thickness of the substrate 23 of the optical fiber array in correspondence with the arrangement pitch and total number of the optical fiber arrangement guide grooves 9 formed in the optical fiber array 1.

Japanese Patent Application No. 2001-347796 discloses the detailed structure in which the thickness of the guide substrate 23 of the optical fiber array 1 to correspond to the arrangement pitch and the total number of the optical fiber arrangement guide grooves 9. The contents of this application are incorporated herein by reference in their entirety. As disclosed in the specification of the above application, by forming the thickness of the guide substrate 23 adequately, even if the total number of the optical fiber arrangement guide grooves 9 is increased, in other words, even if the number of the optical fibers 7 to be arranged is increased, the optical fiber array 1 can be prevented from warping.

In the second embodiment of the invention, the thickness of the substrate 23 (23a) of the optical fiber array 1 (1a), in which forty-eight optical fibers 7 are arranged, is set at the thickness of 1.50 mm. In other words, the thickness of the guide substrate (23a) is set at such a thickness that the warping of the optical fiber array (1a) can be suppressed to the small degree of 0.45 μm when the optical fibers 7 are bonded to be fixed to the guide substrate (23a) of the optical fiber array 1.

Also, in view of the economical efficiency, it is preferable that a silicone wafer is used for forming the substrate 11 of the planar lightwave circuit component 30, and the thickness thereof is generally 1.00 mm. Therefore, also in the second embodiment the thickness of the substrate 11 is 1.00 mm.

In the lightwave circuit module in which the thickness of the substrate 11 differs from the thickness of the guide substrate (23a) as described above, if the substrate 11 and the guide substrate (23a) are arranged to be opposed to each other as in the first embodiment, it becomes difficult to have the bottom surface 17 of the planar lightwave circuit component 30 and the bottom surface of the optical fiber array 1 on the substantially same plane.

Therefore, in the second embodiment, the optical fiber array (1a) is turned upside down. Then, the guide substrate (23a) is opposed to the upper plate 44 of the planar lightwave circuit component 30, and the holding plate (24a) of the optical fiber array (1a) is opposed to the substrate 11 of the planar lightwave circuit component 30.

Then, as shown in FIG. 4(a), a thickness, designated as (b) in FIG. 4(a), of the upper plate 44 of the planar lightwave circuit component 30 is 1.41 mm, and a distance designated as (f) in FIG. 4(a) between the upper surface 15 of the upper plate 44 and the center of the thickness direction of the optical output waveguide 6 is about 1.44 mm. Also, as shown in FIG. 4(b), a thickness (d), designated as (d) in FIG. 4(b), of the holding plate (24a) of the optical fiber array (1a) is 0.96 mm, and a distance designated as (h) in FIG. 4(b) between the center of the optical fiber 7 and the bottom surface 18 of the optical fiber array (1a) is about 1.02 mm.

Incidentally, in the second embodiment, the optical fiber array (1b) is structured similar to the optical fiber array (1b) of the first embodiment. Namely, the guide substrate 23 (23b) of the optical fiber array (1b) and the substrate 11 of the planar lightwave circuit component 30 are opposed to each other, and the upper plate 43 of the planar lightwave circuit component 30 and the holding plate 24 (24b) of the optical fiber array (1b) are opposed to each other.

The second embodiment is structured as described above. As in the first embodiment, since there is substantially no step at the connection sections between the planar lightwave circuit component 30 and the optical fiber arrays 1 (1a, 1b) on both the upper surface 14, 15, 16 side and the bottom surface 17, 18 side, the same effects as in the first embodiment can be obtained.

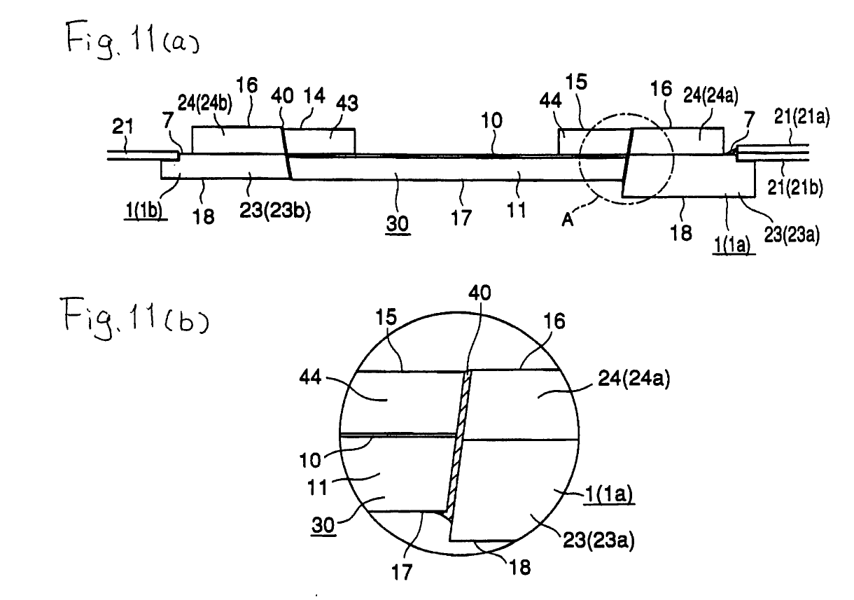

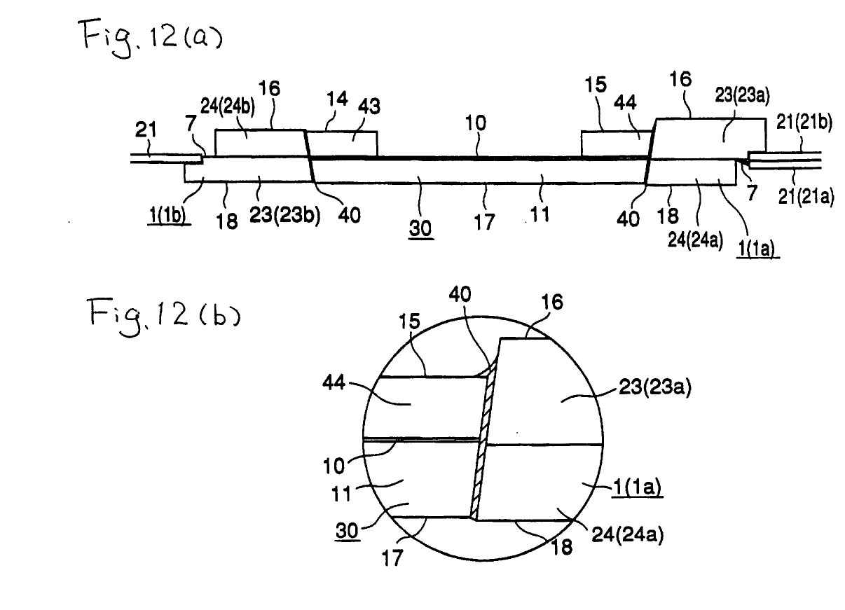

FIG. 11(a) and FIG. 12(a) are sectional views of lightwave circuit module as examples for comparison to the second embodiment. In these examples, the thickness of the guide substrate 23 of the optical fiber array (1a) is 1.5 mm, and the thicknesses of other constituents are the same as those in the conventional module. Also, FIG. 11(b) and FIG. 12(b) respectively show enlarged views of connection sections between the planar lightwave circuit component 30 and the optical fiber arrays (1a), and the connection sections are indicated by circles (A) shown by broken lines in FIG. 11(a) and FIG. 12(a),

As shown in these drawings, if the thickness of the guide substrate 23 of the optical fiber array (1a) is 1.5 mm and the thicknesses of other constituents are the same as those in the conventional module, the embodiment result in as follows. Namely, in the structure of FIGS. 11(a) and 11(b) in which the guide substrate 23 of the optical fiber array (1a) is disposed at the lower side, there is a step between the bottom surface of the planar lightwave circuit component 30 and the bottom surface of the optical fiber array (1a). There is also a step between the upper surface 15 of the planar lightwave circuit component 30 and the upper surface 16 of the optical fiber array (1a).

On the contrary, in the structure shown in FIGS. 12(a) and 12(b) in which the guide substrate 23 of the optical fiber array (1a) is disposed at the upper side, there is a large step between the upper surface 15 of the planar lightwave circuit component 30 and the upper surface 16 of the optical fiber array (1a). There is also a step between the bottom surface 17 of the planar lightwave circuit component 30 and the bottom surface 18 of the optical fiber array (1a).

If there is a large steps as described above, the problem in the conventional optical lightwave circuit module may be worsen. In other words, in the lightwave circuit modules shown in FIGS. 11(a) to 12(b), at the time of first positioning for alignment, for example, the distance or space in the connection section can not be seen at all, so that the optical fiber array 1 (1a) may collide with the planar lightwave circuit component 30. As a result, not only the planar lightwave circuit component 30 and the optical fiber array 1 (1a) may be broken, but also the positioning device may be damaged.

Also, in the lightwave circuit modules shown in FIGS. 11(a) to 12(b), since the adhesive 40 is accumulated more, the stress is applied to the connection section between the planar lightwave circuit component 30 and the optical fiber array 1 (1a), resulting in the change in the insertion loss of the planar lightwave circuit component 30, or damage to the connection section.

As compared with these examples shown in FIGS. 11(a), 11(b), 12(a) and 12(b), in the second embodiment, there is substantially no step at the connection section between the planar lightwave circuit component 30 and the optical fiber array 1 (1a) on both the upper surface 15, 16 side and the lower surface 17, 18 side. Therefore, as in the first embodiment of the invention, excellent alignment between the optical waveguide of the planar lightwave circuit component 30 and the optical fiber 7 can be conducted, and the lightwave circuit module with the high reliability and the high yield can be achieved.

The present invention is not limited to the aforementioned embodiments, and various embodiments can be adopted. For example, in the aforementioned embodiments, the upper surfaces 14, 15, 16 of the planar lightwave circuit component 30 and the optical fiber arrays 1 (1a, 1b) are formed on the substantially same plane, and the bottom surfaces 17, 18 of the planar lightwave circuit component 30 and the optical fiber arrays 1 (1a, 1b) are formed on the substantially same plane. However, in the lightwave circuit module according to the embodiment of the invention, practically, there may be steps of about 10 to about 20 μm (0.01 to 0.02 mm) respectively between the upper surfaces 14, 15, 16 and between the bottom surfaces 17 and 18.

Also, the step may be formed either between the upper surfaces 14, 15, 16 of the planar lightwave circuit component 30 and the optical fiber arrays 1 (1a, 1b), or between the bottom surfaces 17, 18 of the planar lightwave circuit component 30 and the optical fiber arrays 1 (1a, 1b). In this case, the surfaces on the side not having the step therebetween is observed by the CCD camera 48 or the like (in other words, the surfaces are formed on the substantially same plane), to thereby align the optical waveguide of the planar lightwave circuit component 30 and the optical fiber arrays 1 (1a, 1b) and observe the connection section.

However, if the upper surfaces 14, 15, 16 of the planar lightwave circuit component 30 and the optical fiber arrays 1 (1a, 1b) are formed on the substantially same plane, and the bottom surfaces 17, 18 of the planar lightwave circuit component 30 and the optical fiber arrays 1 (1a, 1b) are formed on the substantially same plane, the accumulation of the adhesive 40 can be much more securely suppressed, to thereby further improve the reliability of the lightwave circuit module.

Furthermore, although the upper plates 43, 44 are formed only at connection end surface sides of the planar lightwave circuit component 30, the upper plates can be formed on the entire area of the upper side of the waveguide forming region 10. Also, the upper plates are not limited to be disposed at both end sides of the planar lightwave circuit component 30, and can be disposed at only one end side of the planar lightwave circuit component 30. Alternatively, the upper plates can be provided at two adjacent end surfaces.

Although there has been explained with the example in which the connection end surfaces of the planar lightwave circuit component 30 and the connection end surfaces of the optical fiber array 1 (1a, 1b) are ground obliquely in the aforementioned embodiments, these connection end surfaces are not limited to be formed obliquely. Also, the method of forming the connection end surfaces of the planar lightwave circuit component 30 and the optical fiber arrays 1 (1a, 1b) is not limited to the grinding, and can be formed by cutting.

Although the planar lightwave circuit component 30 in the embodiments of the invention has a circuit structure of the arrayed waveguide grating shown in FIG. 8, the circuit structure of the planar lightwave circuit component 30 is not specifically limited thereto, and can be various arrayed waveguide gratings that have been proposed, Mach-Zehnder interferometer circuit, splitters or the like.

Further, although the substrate 11 of the planar lightwave circuit component 30 is the silicon substrate having the thickness of 1.00 mm in the embodiments, the substrate 11 can be a silica substrate. Also, the thickness of the substrate 11 can be the one selected from a plurality of thicknesses (for example, 0.5 mm, 1.0 mm, 1.5 mm) of the substrates commercially available, which are set stepwisely.

Although the optical fiber array 1 includes the guide substrate 23 and the holding plate 24 in the embodiments, the structure of the optical fiber array 1 is not specifically limited thereto, and can be modified adequately. For example, the optical fiber array may be the one such as an optical fiber ferrule having insertion holes for the optical fibers 7.

According to the embodiments of the present invention, since at least the upper surfaces of the planar lightwave circuit component forming the lightwave circuit module and the optical fiber array, or the bottom surfaces of the planar lightwave circuit component and the optical fiber array are arranged on the substantially same plane, the optical waveguide of the planar lightwave circuit component and the optical fiber of the optical fiber array can be aligned efficiently and accurately.

Also, in the present invention, according to the above structure, since the connection section between the planar lightwave circuit component and the optical fiber array can be observed precisely. Therefore, the space between the connection end surface of the planar lightwave circuit component and the connection end surface of the optical fiber array can be easily adjusted, and can be formed as designed. Therefore, there is no such incidence that the stress is applied to the connection section between the planar lightwave circuit component and the optical fiber array to lower the reliability at the connection section. Accordingly, the lightwave circuit module with the high reliability can be achieved with the excellent yield.

Also, in the embodiments of the present invention, according to the structure in which the optical fiber array includes the guide substrate provided with the optical fiber arrangement guide grooves for inserting the optical fiber therein, and the holding plate for holding the optical fibers inserted in the optical fiber arrangement guide grooves in the guide substrate, the optical fibers can be arranged easily and precisely. Therefore, the optical fiber array with the excellent yield can be achieved, and the yield of the lightwave circuit module can be further improved.

In one of the embodiments of the present invention, according to the structure in which the holding plate of the optical fiber array and the substrate of the planar lightwave circuit component are opposed to each other and the upper plate formed on the planar lightwave circuit component and the guide substrate of the optical fiber array are opposed to each other, in case the thickness of the substrate of the planar lightwave circuit component is set in advance, the selection range of the thickness of the guide substrate of the optical fiber array can be widened.

In other words, in this case, the thickness of the upper plate of the planar lightwave circuit component is set to the thickness corresponding to the thickness of the guide substrate of the optical fiber array, so that at least the upper surfaces of the planar lightwave circuit component and the optical fiber array, or the bottom surfaces of the planar lightwave circuit component and the optical fiber array can be formed on the substantially same plane.

Moreover, in one of the embodiments of the invention, the holding plate is disposed at the lower side of the optical fiber array and the guide substrate is disposed upper side such that the bottom surface of the guide substrate constitutes the upper surface of the optical fiber array. In this structure, the distance between the upper surface of the optical fiber array and the center of the optical fiber is set larger than the distance between the center in the thickness direction of the optical waveguide formed in the planar lightwave circuit component and the bottom surface of the planar lightwave circuit component. According to this structure, the thickness of the guide substrate of the optical fiber array can be adequately formed thicker to correspond to the number of the optical fiber arrangement guide grooves of the optical fiber array, for example.

In the embodiment of the invention, according to the structure in which the optical fibers of the optical fiber array are bonded and fixed to the optical fiber arrangement guide grooves of the guide substrate and the guide substrate has such a thickness that the warping of the optical fiber array at the time of bonding the optical fibers can be suppressed, the increase in the connection loss or the peeling at the connection section between the optical fiber array and the planar lightwave circuit component can be suppressed, to thereby further improve the reliability.

Also, in the invention, according to the structure in which the guide substrate of the optical fiber array has the thickness of 1.07 mm or more, the holding plate of the optical array is disposed at the lower side and the guide substrate is disposed at the upper side, so that at least the upper surfaces of the planar lightwave circuit component and the optical fiber array, or the bottom surfaces of the planar lightwave circuit component and the planar lightwave circuit component can be easily formed on the substantially same plane.

Furthermore, in the embodiments of the present invention, according to the structure that the thickness of the substrate of the planar lightwave circuit component is one selected from a plurality of thicknesses set stepwisely, the lightwave circuit module can be formed by selecting and using the substrate with the selected thickness from among a plurality of the commercially available substrates, for example. Accordingly, the lightwave circuit module at low cost can be achieved.

In the embodiments of the present invention, according to the structure in which the thickness of the substrate of the planar lightwave circuit component is about 1.00 mm, the planar lightwave circuit component can be formed by using the substrate having the thickness which is used most generally. Therefore, the cost of the lightwave circuit module can be further lowered.

Still further, in the embodiments of the present invention, according to the structure in which the substrate of the planar lightwave circuit component constitutes a silicon substrate, the lightwave circuit module can be formed by using the silicon substrate which is used most generally, to thereby further lower the cost of the lightwave circuit module.

In the embodiments of the present invention, according to the structure in which the planar lightwave circuit component and the optical fiber array are fixed by the adhesive, there can be achieved the lightwave circuit module which is manufactured with the good productivity by applying the conventional skill. Accordingly, the lightwave circuit module at much lower cost can be achieved.

Obviously, numerous modifications and variations of the present invention are possible in light of the above teachings. It is therefore to be understood that within the scope of the appended claims, the invention may be practiced otherwise than as specifically described herein.

What is claimed as new and desired to be secured by Letters Patent of the United States is:

1. A planar lightwave circuit module comprising:
a planar lightwave circuit component including a substrate having upper, bottom and end substrate surfaces, a waveguide forming region including at least one optical waveguide being formed on the upper substrate surface;
a plate having upper, bottom and end plate surfaces and provided on the substrate such that the bottom plate surface of the plate contacts the waveguide forming region;
an optical fiber array including upper, bottom and end array surfaces and at least one optical fiber, the end array surface of the optical fiber array being connected to the end substrate surface of the substrate and the end plate surface of the plate such that the at least one optical fiber is connected to the at least one optical waveguide and such that the bottom substrate surface of the substrate and the bottom array surface of the optical fiber array are substantially on a first plane and/or the upper plate surface of the plate and the upper array surface of the optical fiber array are substantially on a second plane.

2. A planar lightwave circuit module according to claim 1, wherein the optical fiber array comprises,
a guide substrate having upper and bottom guide substrate surfaces, at least one optical fiber arrangement guide groove being formed on the upper guide substrate surface, the at least one optical fiber is inserted into the at least one optical fiber arrangement guide groove; and
a holding plate having upper and bottom holding plate surfaces and provided on the guide substrate such that the bottom holding plate surface of the holding plate opposes the upper guide substrate surface of the guide substrate to hold the at least one optical fiber in the at least one optical fiber arrangement guide groove.

3. A planar lightwave circuit module according to claim 2, wherein the guide substrate has an end guide substrate surface and the holding plate has an end holding plate surface, and wherein the end guide substrate surface of the guide substrate is connected to the end substrate surface of the substrate and the end holding plate surface of the holding plate is connected to the end plate surface of the plate.

4. A planar lightwave circuit module according to claim 2, wherein a guide substrate has an end guide substrate surface and the holding plate has an end holding plate surface, and wherein the end guide substrate surface of the guide substrate is connected to the end plate surface of the plate and the end holding plate surface of the holding plate is connected to the end substrate surface of the substrate, and wherein the bottom guide substrate surface constitutes the upper array surface of the optical fiber array and the upper holding plate surface constitutes the bottom array surface of the optical fiber array.

5. A planar lightwave circuit module according to claim 4, wherein a distance between the bottom guide substrate surface of the guide substrate and a center of the at least one optical fiber is larger than a distance between the bottom substrate surface of the substrate and a center of the at least one optical waveguide.

6. A planar lightwave circuit module according to claim 2, wherein the at least one optical fiber is adhered to a surface of the at least one optical fiber arrangement guide groove, and wherein the guide substrate has a thickness enough to suppress a warp of the optical fiber array.

7. A planar lightwave circuit module according to claim 2, wherein the guide substrate has a thickness of at least 1.07 mm.

8. A planar lightwave circuit module according to claim 1, wherein the substrate of the planar lightwave circuit component has a thickness which is selected from a plurality of predetermined thicknesses.

9. A planar lightwave circuit module according to claim 1, wherein the substrate of the planar lightwave circuit component has a thickness of about 1 mm.

10. A planar lightwave circuit module according to claim 1, wherein the substrate of the planar lightwave circuit component is made of silicon.

11. A planar lightwave circuit module according to claim 1, wherein an adhesive is provided between the end array surface of the optical fiber array and the end substrate surface of the substrate and between the end array surface of the optical fiber array and the end plate surface of the plate to fix the optical fiber array to the substrate and the plate.

12. A planar lightwave circuit module according to claim 1, wherein a distance between the bottom substrate surface of the substrate and the bottom array surface of the optical fiber array and/or a distance between the upper plate surface of the plate and the upper array surface of the optical fiber array are at most about 20 μm.

13. A planar lightwave circuit module according to claim 1, wherein the plate is provided on the substrate such that the bottom plate surface of the plate contacts an entirety of the waveguide forming region.

14. A planar lightwave circuit module according to claim 1, wherein the plate is provided on the substrate such that the bottom plate surface of the plate contacts a part of the waveguide forming region.

15. A planar lightwave circuit module according to claim 1, wherein the end substrate surface of the substrate, end plate surface of the plate and the end array surface of the optical fiber array are inclined surfaces.

16. A method for manufacturing a planar lightwave circuit module, comprising:
forming a waveguide forming region including at least one optical waveguide on an upper substrate surface of a substrate of a planar lightwave circuit component;
providing a plate on the substrate such that a bottom plate surface of the plate contacts the waveguide forming region; and
connecting an end array surface of an optical fiber array to an end substrate surface of the substrate and an end plate surface of the plate such that at least one optical fiber of the optical fiber array is connected to the at least one optical waveguide and such that a bottom substrate surface of the substrate and a bottom array surface of the optical fiber array are substantially on a first plane and/or an upper plate surface of the plate and an upper array surface of the optical fiber array are substantially on a second plane.

17. A method according to claim 16, further comprising:
forming at least one optical fiber arrangement guide groove on an upper guide substrate surface of a guide substrate;
inserting the at least one optical fiber into the at least one optical fiber arrangement guide groove; and
providing a holding plate on the guide substrate such that a bottom holding plate surface of the holding plate opposes the upper guide substrate surface of the guide substrate to hold the at least one optical fiber in the at least one optical fiber arrangement guide groove.

18. A method according to claim 17, wherein an end guide substrate surface of the guide substrate is connected to the end substrate surface of the substrate, and wherein an end holding plate surface of the holding plate is connected to the end plate surface of the plate.

19. A method according to claim 17, wherein an end guide substrate surface of the guide substrate is connected to the end plate surface of the plate and an end holding plate surface of the holding plate is connected to the end substrate surface of the substrate, and wherein a bottom guide substrate surface of the guide substrate constitutes the upper array surface of the optical fiber array and an upper holding plate surface constitutes the bottom array surface of the optical fiber array.

20. A method according to claim 19, wherein a distance between the bottom guide substrate surface of the guide substrate and a center of the at least one optical fiber is larger than a distance between the bottom substrate surface of the substrate and a center of the at least one optical waveguide.

21. A method according to claim 17, further comprising:
adhering the at least one optical fiber to a surface of the at least one optical fiber arrangement guide groove, the guide substrate having a thickness enough to suppress a warp of the optical fiber array.

22. A method according to claim 17, wherein the guide substrate has a thickness of at least 1.07 mm.

23. A method according to claim 16, further comprising:
selecting a thickness of the substrate of the planar lightwave circuit component from a plurality of predetermined thicknesses.

24. A method according to claim 16, wherein the substrate of the planar lightwave circuit component has a thickness of about 1 mm.

25. A method according to claim 16, wherein the substrate of the planar lightwave circuit component is made of silicon.

26. A method according to claim 16, further comprising:
providing an adhesive between the end array surface of the optical fiber array and the end substrate surface of the substrate and between the end array surface of the optical fiber array and the end plate surface of the plate to fix the optical fiber array to the substrate and the plate.

27. A method according to claim 16, wherein a distance between the bottom substrate surface of the substrate and the bottom array surface of the optical fiber array and/or a distance between the upper plate surface of the plate and the upper array surface of the optical fiber array are at most about 20 μm.

28. A method according to claim 16, wherein the plate is provided on the substrate such that the bottom plate surface of the plate contacts an entirety of the waveguide forming region.

29. A method according to claim 16, wherein the plate is provided on the substrate such that the bottom plate surface of the plate contacts a part of the waveguide forming region.

30. A method according to claim 16, wherein the end substrate surface of the substrate, end plate surface of the plate and the end array surface of the optical fiber array are inclined surfaces.
